(19) United States
(12) Patent Application Publication
(10) Pub. No.: US 2024/0326596 A1
(43) Pub. Date: Oct. 3, 2024

(54) Device and Method for Controlling and Supplying Energy to Components in Vehicles

(71) Applicant: KNORR-BREMSE Systeme fuer Nutzfahrzeuge GmbH, Muenchen (DE)

(72) Inventors: Huba NEMETH, Budapest (HU); Oliver JUNDT, Hessigheim (DE); Jens-Hauke MUELLER, Velbert-Neviges (DE)

(21) Appl. No.: 18/576,410

(22) PCT Filed: Jul. 6, 2022
(86) PCT No.: PCT/EP2022/068742

§ 371 Date: Jan. 4, 2024

(30) Foreign Application Priority Data
Jul. 6, 2022 (DE) 10 2021 207 375.1

(51) Int. Cl. B60L 1/00; B60T 13/74; B62D 5/04

(52) U.S. Cl. CPC B60L 1/003; B60T 13/74; B62D 5/0406; B62D 5/0457; B60L 2200/00; B60T 2270/402; B60T 2270/414

(57) ABSTRACT

A device for controlling and supplying energy to components in vehicles, in particular utility vehicles, includes at least one support element which is paired with at least one first actuator component, and a first energy storage device which is mounted on the support element and which is designed to supply energy to the first actuator component. The first actuator component and/or at least one first controller is mounted on the support element, the first controller being designed to at least partly actuate the first actuator component. Additionally, at least one second controller can be mounted on the support element. The second controller is designed to at least partly actuate at least one second actuator component, wherein the support element is not paired with the second actuator component. Alternatively or in addition to the second controller, a second energy storage device can be mounted on the support element. The second energy storage device is designed to supply energy to the second actuator component.

### BACKGROUND AND SUMMARY

The invention relates to a device and a method for controlling and supplying energy to components in vehicles, in particular commercial vehicles. The invention relates in particular to an, optionally redundant, energy supply and management system for consumer components in vehicles.

Such energy supply and management systems are relevant in particular in connection with automated or autonomous operation of vehicles (highly automated driving—HAD) or in connection with the electrification of vehicle components, in particular of actuators and/or of the drive. Individual system components must here be redundantly provided in order, for example, to ensure the safety of further driving operation in the event of a failure of an energy supply or in the event of faults in the system, so that the vehicle can at least come safely to a stop. Safety-critical components are thus provided in a redundant, multiple design, for example in each case as a primary component and one or more secondary or substitute components. The latter may optionally have a lower capability, since they are typically used only in an emergency and/or only for a short time.

In electrical systems, energy stores in the form of electric batteries can be drained, for example, or faults can occur in the electronic controller and/or sensor system of the vehicle. The consumers or components that are affected in such a case relate in particular to the steering, the brakes and/or the drive of the vehicle, although other consumers or components are also conceivable. The consumers or components may be actuators or actuator components which perform or implement a respective function, or also computer and/or sensor units. Such consumers or components can be supplied with energy and operated in different ways, for example electrically and/or pneumatically (compressed air) and/or hydraulically.

In known energy supply and management systems of this type, individual components, for example components of the energy supply, of the energy store or of the electronic controller and the consumers as such or the actuators thereof, have hitherto been arranged or installed in the vehicle at different locations and optionally spatially separate from one another. Generally, individual partial functional units which belong together functionally are again arranged in or on the vehicle at different locations and/or spatially separate from one another. Typically, each of these components or partial functional units is mounted or accommodated on its own support or in its own housing.

This means that, in the known energy supply and management systems, there is a large number of supports, mounts or housings each with its respective components mounted thereon or therein. In addition, a large number of additional components, such as connections, lines, cables and the like, is necessary for the functional interaction of these components, and these additional components correspondingly extend through the vehicle. This in turn means a high outlay for the installation of these components and accessory parts into the vehicle and in each case also a large amount of space which these components and parts require. Not least, this results in increased costs for the production, or installation, operation and maintenance of these components and parts and thus of the vehicle as a whole.

Accordingly, the invention is based on the object of overcoming the problems described above. The object of the invention is, therefore, in particular to reduce the large number of supports, mounts or housings on or in which components of an, in particular redundant, energy supply and management system are accommodated. In this way, the large number of additional components, such as connections, lines, cables and the like, for the installation and connection of the supports or housings and/or of the components and (partial) functional units and modules accommodated thereon or therein with one another, is also to be reduced.

According to the invention, this object is achieved by a device for controlling and supplying energy to components in vehicles, in particular commercial vehicles, and by a corresponding method, in accordance with the independent claims.

According to the invention there is thus provided a device for controlling and supplying energy to components in vehicles, in particular commercial vehicles, which has the following features: at least one support element which is associated with at least one first actuator component; a first energy storage device which is mounted on the at least one support element and is configured to supply energy to the at least one first actuator component; wherein the at least one first actuator component and/or at least one first control device are/is mounted on the at least one support element, wherein the at least one first control device is configured to at least partly activate the at least one first actuator component.

The device according to the invention can additionally provide that at least one second control device is mounted on the at least one support element, wherein the at least one second control device is configured to at least partly activate the at least one first actuator component and/or at least one second actuator component, wherein the at least one support element is preferably not associated with the at least one second actuator component.

Alternatively or in addition to the at least one second control device, at least one second energy storage device can additionally be mounted on the at least one support element, said at least one second energy storage device being configured to supply energy to the at least one second actuator component.

Preferably, the first and second actuator components are each consumer devices of the vehicle, in particular safety-relevant consumer devices, which must function safely and reliably especially also in the case of the automated or autonomous operation of vehicles or in connection with the electrification of vehicle components, in particular of actuators and/or of the drive, for example when associated energy supply devices or energy storage devices or control and/or closed-loop control devices fail or are defective.

Such actuator components or consumer devices are in particular devices for steering a vehicle, in particular steering actuators, devices for braking a vehicle, in particular brake actuators, or devices for driving a vehicle, in particular drive actuators, which are used in particular in the case of HAD. Actuator components within the meaning of the application can further be understood as being detection means, such as sensors (e.g. radar sensors or camera-based sensors), as well as computer units and/or lighting devices. Further safety-critical actuator components or consumer devices are likewise contemplated.

Thus, within the meaning of the present invention, a first actuator component can be, for example, a steering actuator, and another or second actuator component can be, for example, a brake actuator, or vice versa. In a vehicle there can typically be one or more first and one or more second actuator components, that is to say, for example, one or more steering actuators and one or more brake actuators. In a vehicle there can thus be, for example, a brake actuator at each wheel of the vehicle, and consequently at least four brake actuators. There can be, for example, one or more steering actuators on steerable axles, that is to say, for example, on the front axle and/or the rear axle and/or on trailing and/or leading axles of a (commercial) vehicle.

The types of actuators or actuator components in a vehicle are not limited to two. Rather, there can be any desired further types of actuators or actuator components. In this respect, the present mention of first and/or second actuator components is understood merely as being representative of an arbitrary number or an arbitrarily continuable series of different types of actuators or actuator components.

Within the meaning of the present invention, an actuator component can further be, for example, the actuator as a whole (e.g. steering or brake actuator) or also only part thereof, such as, for example, a servomotor, a piston or a sensor of the actuator, or an expedient combination of such parts which are combined to form an assembly or a module.

Actuators or actuator components in a vehicle are typically connected to suitable energy supply devices and/or energy storage devices and/or control and/or closed-loop control devices. The device according to the invention can be configured, for example, such that the first and/or the second control device and/or the first and/or the second energy storage device are configured to communicate with at least one brake actuator and/or at least one steering actuator and/or at least one drive actuator or an actuator for HAD.

In a preferred embodiment of the device according to the invention, it can be provided that the at least one support element is associated with at least one steering actuator (first actuator); that the first energy storage device is mounted on the at least one support element and is configured to supply energy to the at least one steering actuator; and that the at least one first control device is mounted on the at least one support element and is configured to activate the at least one steering actuator. Optionally, the steering actuator (first actuator) can also be mounted on the support element.

This embodiment of the device according to the invention can additionally provide that a second control device is mounted on the at least one support element, said second control device being configured to activate at least one brake actuator (second actuator or actuator other than the first actuator), and/or that a second energy storage device is mounted on the at least one support element, said second energy storage device being configured to supply energy to the at least one brake actuator. Within the meaning of the invention, the support element is thus associated, in particular functionally associated, in this embodiment with the steering actuator (first actuator), while the support element is not associated, in particular functionally, with the brake actuator (second, other actuator). In particular, the brake actuator is here not mounted on the support element.

In a corresponding, but different preferred embodiment of the device according to the invention, it can be provided that the at least one support element is associated with at least one brake actuator (first actuator); that the first energy storage device is mounted on the at least one support element and is configured to supply energy to the at least one brake actuator; and that the at least one first control device is mounted on the at least one support element and is configured to activate the at least one brake actuator. Optionally, the brake actuator (first actuator) can also be mounted on the support element.

This embodiment of the device according to the invention can additionally provide that a second control device is mounted on the at least one support element, said second control device being configured to activate at least one steering actuator (second actuator or actuator other than the first actuator), and/or that a second energy storage device is mounted on the at least one support element, said second energy storage device being configured to supply energy to the at least one steering actuator. Within the meaning of the invention, the support element is thus associated, in particular functionally associated, in this embodiment with the brake actuator (first actuator), while the support element is not associated, in particular functionally, with the steering actuator (second, other actuator). In particular, the steering actuator is here not mounted on the support element.

In the two alternative embodiments of the invention described hereinbefore, the device as a whole can be arranged or mounted spatially in the vicinity of at least one brake actuator and/or of at least one steering actuator. The brake actuator and/or steering actuator in question is then generally mounted or arranged not on the support element but in the vicinity next to the support element, while other brake actuators and/or steering actuators can be mounted on the support element.

In addition or alternatively, the device as a whole can be arranged or mounted spatially in the vicinity of at least one steering actuator and/or of a front axle or of a rear axle of a vehicle. The steering actuator in question is then again generally mounted or arranged not on the support element but in the vicinity next to the support element. In both cases described hereinbefore, a spatially optimized, space-saving arrangement and design of the system as a whole is thus realized in the vehicle.

According to a preferred embodiment of the device according to the invention, the support element comprises a housing, wherein the first and/or second control device and/or the first and/or second energy storage device is mounted in or on the housing. The respective control device and/or the respective energy storage device can thus be integrated into the housing.

Other components can also additionally be accommodated in the housing. The control devices and/or the energy storage devices and/or further components can additionally also be mounted partially or wholly externally on the housing, that is to say some of the components and devices can be mounted internally in the housing and other components and devices can be mounted externally on the housing. The support element can alternatively also be a support plate or the like, on which the components and devices are mounted.

As has already been mentioned at the beginning, the consumers, actuators, detection means or other components of the vehicle can be supplied and operated in terms of energy in different ways, for example electrically and/or pneumatically (compressed air) and/or hydraulically. The first and/or the second energy storage device of the device according to the invention can thus supply electrical energy and/or pneumatic energy and/or hydraulic energy to the first and/or second actuator component in question.

The invention also provides a method for controlling and supplying energy to components in vehicles, in particular commercial vehicles, wherein the method uses the above-described device according to the invention.

The invention additionally provides a vehicle which uses the above-described device according to the invention and/or the above-described method according to the invention.

The vehicle according to the invention can be in particular a commercial vehicle, a truck, a trailer, a bus, and/or a combination of a towing vehicle and a trailer. In addition or alternatively, the vehicle can be in the form of an electric, hybrid or conventional vehicle with a combustion engine.

Further details and advantages of the invention will become apparent from the following description of an embodiment of the invention in conjunction with the accompanying drawing.

### BRIEF DESCRIPTION OF THE DRAWING

FIG. 1 shows, schematically in a plan view from above, a vehicle which uses the device according to an embodiment of the invention.

### DETAILED DESCRIPTION OF THE DRAWING

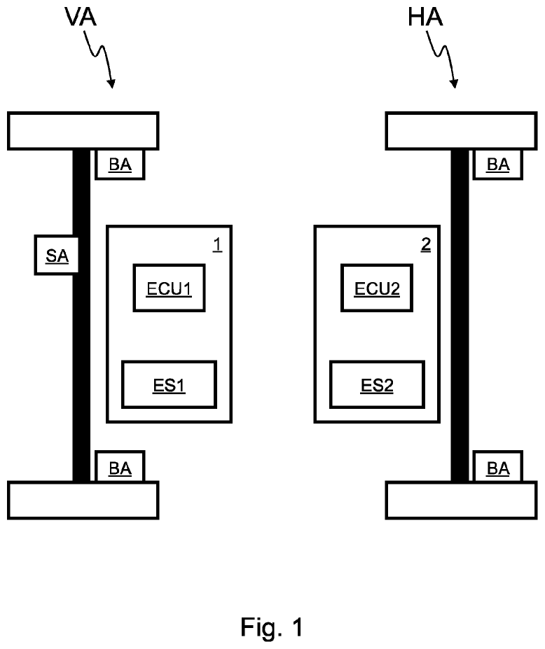

The schematic vehicle shown in FIG. 1 has a direction of travel in the drawing from right to left. The vehicle has a front axle VA and a rear axle HA. A brake actuator BA is arranged on or in the vicinity of each of the four wheels of the vehicle (two wheels are shown schematically on each of the front axle VA and the rear axle HA). A steering actuator SA is arranged on or in the vicinity of the steerable front axle VA.

A support element 1, in particular comprising a housing, is arranged on or in the vicinity of the front axle VA. A corresponding support element 2, in particular comprising a housing, is arranged on or in the vicinity of the rear axle HA.

An energy storage device ES1 and a control device ECU1 are arranged in or on the support element or housing 1. In a corresponding manner, an energy storage device ES2 and a control device ECU2 are arranged in or on the support element or housing 2. In particular, the housings 1, 2 are primarily housings for the energy stores ES1, ES2, in which the control devices ECU1, ECU2 are additionally also accommodated.

The control devices ECU1 and ECU2 can, in particular, comprise electronic controllers and corresponding additional components for the steering, the brake and/or further consumer devices of the vehicle, for example (additional) drive devices or detection devices.

Power lines (not shown in the drawing for reasons of clarity) can lead, for example, from the energy storage devices ES1, ES2 to the brake actuators BA and/or to the steering actuator SA. Control lines (likewise not shown in the drawing) can lead from the control devices ECU1, ECU2, for example, to the brake actuators BA and/or to the steering actuator SA. Furthermore, data lines can lead from detection devices to the control devices ECU1, ECU2, and power lines can lead from the energy storage devices ES1, ES2 to the detection devices.

The support element 1 shown in FIG. 1 (the same also applies analogously to the support element 2) can be associated, for example, with the steering actuator SA. The first energy storage device ES1 is mounted on the support element 1 and configured to supply energy, in particular electrical energy, to the steering actuator SA. A first control device ECU1 is additionally mounted on the support element 1 and is configured to activate the steering actuator SA in order to operate it.

As is not explicitly shown in FIG. 1, a second control device ECU2 can additionally be mounted on the support element 1, said second control device being configured to activate at least one brake actuator BA. In addition or alternatively, a second energy storage device ES2 can also be mounted on the support element 1, said second energy storage device being configured to supply energy, in particular electrical energy, to the at least one brake actuator BA.

Correspondingly, the support element 1 shown in FIG. 1 can alternatively be associated, for example, with at least one of the brake actuators BA (i.e. in this case not with the steering actuator SA as mentioned in the preceding example). The first energy storage device ES1 is mounted on the support element 1 and configured to supply energy, in particular electrical energy, to the at least one brake actuator BA. A first control device ECU1 is additionally mounted on the support element 1, said first control device being configured to activate the at least one brake actuator BA in order to operate it.

As is not explicitly shown in FIG. 1, a second control device ECU2 can additionally be mounted on the support element 1, said second control device being configured to activate the or at least one steering actuator SA. In addition or alternatively, a second energy storage device ES2 can also be mounted on the support element 1, said second energy storage device being configured to supply energy, in particular electrical energy, to the at least one steering actuator SA.

What has been said above in relation to the support element 1 applies analogously also to the support element 2 shown in FIG. 1.

As is apparent from FIG. 1, the entire device comprising the support element 1 and/or the support element 2 can be arranged or mounted spatially in the vicinity of at least one of the plurality of brake actuators BA and/or of the steering actuator SA. In addition or alternatively, the entire device can be arranged or mounted spatially in the vicinity of the steering actuator SA and/or of the front axle VA and/or of the rear axle HA of the vehicle.

The device comprising the support element 1 and/or the support element 2 is thus compact and space-saving overall, because it accommodates components which would otherwise be arranged at other locations in the vehicle. As a result of its compact form and as a result of its arrangement within a vehicle (e.g. in the vicinity of a consumer unit in question, e.g. on the front axle VA and/or in the vicinity of the steering actuator SA), it thus contributes toward lower space and volume consumption in the vehicle.

### LIST OF REFERENCE SIGNS

1 support element, housing
2 support element, housing
ES1 energy storage device
ES2 energy storage device
ECU1 control device
ECU2 control device
SA steering actuator
BA brake actuator

1.-16. (canceled)

17. A device for controlling and supplying energy to components in commercial vehicles, comprising:
at least one support element which is associated with at least a first actuator component;
a first energy storage device which is mounted on the at least one support element and is configured to supply energy to the at least one first actuator component, wherein
the at least one first actuator component and/or at least one first control device are/is mounted on the at least one support element, and
the at least one first control device is configured to at least partly activate the at least one first actuator component.

18. The device according to claim 17, wherein
at least one second control device is mounted on the at least one support element,
the at least one second control device is configured to at least partly activate the at least one first actuator component and/or at least one second actuator component, and
the at least one support element is not associated with the at least one second actuator component.

19. The device according to claim 17, wherein
a second energy storage device is mounted on the at least one support element, said second energy storage device being configured to supply energy to the at least one second actuator component.

20. The device according to claim 18, wherein
the at least one first actuator component and/or the at least one second actuator component comprise safety-relevant consumer devices of the vehicle.

21. The device according to claim 20, wherein
the safety relevant consumer devices of the vehicle are of a group comprising:
a steering actuator, a brake actuator, and/or an actuator, sensor and/or a computer for highly automated driving and/or a lighting unit.

22. The device according to claim 18, wherein
the first and/or the second control device and/or the first and/or the second energy storage device are configured to communicate with one or more of: a brake actuator, a steering actuator, or an actuator for highly automated driving.

23. The device according to claim 18, wherein
the at least one support element is associated with at least one steering actuator,
the first energy storage device is mounted on the at least one support element and is configured to supply energy to the at least one steering actuator, and
the at least one first control device is mounted on the at least one support element and is configured to activate the at least one steering actuator.

24. The device according to claim 23, wherein
a second control device is mounted on the at least one support element, said second control device being configured to activate at least one brake actuator, and/or
a second energy storage device is mounted on the at least one support element, said second energy storage device being configured to supply energy to the at least one brake actuator.

25. The device according to claim 18, wherein
the at least one support element is associated with at least one brake actuator;
the first energy storage device is mounted on the at least one support element and is configured to supply energy to the at least one brake actuator;
the at least one first control device is mounted on the at least one support element and is configured to activate the at least one brake actuator.

26. The device according to claim 25, wherein
a second control device is mounted on the at least one support element, said second control device being configured to activate at least one steering actuator, and/or
a second energy storage device is mounted on the at least one support element, said second energy storage device being configured to supply energy to the at least one steering actuator.

27. The device according to claim 23, wherein
The at least one steering actuator and/or at least one brake actuator are/is mounted on the support element.

28. The device according to claim 23, wherein
the device is configured to be mounted spatially in a vicinity of at least one brake actuator and/or of at least one steering actuator.

29. The device according to claim 23, wherein
the device is configured to be mounted spatially in a vicinity of at least one steering actuator and/or a front or rear axle of a vehicle.

30. The device according to claim 19, wherein
the support element comprises a housing, and
the first and/or a second control device and/or the first and/or a second energy storage device are/is mounted in or on the housing.

31. The device according to claim 17, wherein
the first and/or second energy storage device supplies electrical energy, pneumatic energy, and/or hydraulic energy to the respective first and/or a second actuator component.

32. A commercial vehicle comprising a device according to claim 17.

33. A method for controlling and supplying energy to components in commercial vehicles utilizing the device according to claim 17.
